(19) United States
(12) Patent Application Publication
(10) Pub. No.: US 2009/0305912 A1
(43) Pub. Date: Dec. 10, 2009

(54) METHOD FOR MITIGATING THE SALINITY OF DRILLING WASTE

(76) Inventor: Michael J. McDonald, Toronto (CA)

Correspondence Address: BUCHANAN INGERSOLL & ROONEY PC, P.O. BOX 1404, ALEXANDRIA, VA, 22313-1404, US

(21) Appl. No.: 12/479,387

(22) Filed: Jun. 5, 2009

Related U.S. Application Data
(60) Provisional application No. 61/059,310, filed on Jun. 6, 2008.
(60) Provisional application No. 61/184,083, filed on Jun. 4, 2009.

(51) Int. Cl. C09K 8/20

(52) U.S. Cl. 507/108; 507/106

(57) ABSTRACT

The present invention relates to a method for ameliorating the salinity of drilling waste that is generated over the course of drilling for oil & gas using water-based drilling fluid. In particular for drilling waste that is generated when using a potassium silicate-based drilling fluid. Salinity is a common problem since salt-based additives are commonly added to drilling fluids to obtain certain desirable properties such as shale inhibition. Potassium salts represents a commonly used drilling fluid additive to inhibit the swelling and dispersion of shale. Salinity in the drilling fluid can further increase as a result of drilling fluid contact with the geological formations being drilled.

### CROSS-REFERENCE TO RELATED APPLICATION

This application claims priority to pending U.S. Provisional Patent Application Ser. No. 61/059,310 filed Jun. 6, 2008 and U.S. Provisional Patent Application Ser. No. 61/184,083 filed Jun. 4, 2009. U.S. Provisional Patent Application Ser. No. 61/059,310 and U.S. Provisional Patent Application Ser. No. 61/184,083 are incorporated by reference into this application as if fully rewritten herein.

### BACKGROUND OF INVENTION

With very few exceptions, regulatory bodies have a link between the salinity of the drilling waste and disposal method. Drilling waste salinity therefore plays a pivotal role in determining the disposal method and subsequent cost. On-site and/or surface disposal methods represent the preferred options for land-based drilling. To preserve the quality of soil, drilling waste must not adversely increase background soil salinity. Detrimental effects to adversely increasing soil salinity includes; decrease in available water and nutrients to vegetation, swelling of soil clays, poor aeration and percolation.

Salinity is typically measured using the criteria of:

electrical conductivity (EC)

sodium adsorption ratio (SAR)

sodium content

The challenge for many types of water-based drilling fluids is to impart adequate drilling fluid properties such as shale inhibition without excessively increasing drilling fluid salinity. Sodium levels in the drilling fluid can be reduced by formulating with potassium based products vs. sodium based products (ex. potassium silicate vs. sodium silicate). Nonetheless, sodium often enters the drilling fluid as potassium exchanges for sodium on clay-based surfaces.

In the case of potassium silicate based drilling waste there is typically a moderate amount of sodium, moderate electrical conductivity but a high Sodium Absorption Ratio value. Typically, the SAR requirements can be met by the addition of a soluble calcium and/or magnesium salt (i.e. gypsum, epsom). The disadvantage of amending drilling waste with calcium (magnesium) salts is a further increase in the electrical conductivity. Alternatively, certain humic substances appear to have the performance advantage of being able to maintain or lower electrical conductivity as well as reduce SAR

During the drilling of an oil and gas well, a specialized fluid referred to as a drilling fluid or alternatively a “mud” is circulated through the drill pipe and bit. The principal functions of a drilling fluid includes cooling and lubricating the drill bit, providing hydrostatic pressure, stabilizing geological formations and carrying drill cuttings beneath the bit to transport them up to the surface for separation. The process of drilling an oil or gas well generates a large volume of drill waste in the form of spent drilling fluids and drill cuttings. Toxicity and salinity are two top items that determine the method and subsequent costs associated with the disposal of drilling waste.

Drilling fluids can be categorized as being either water-based or oil-based. Water-based drilling fluids generally being lower cost and having much better HS&E (health, safety and environment) performance than oil-based drilling fluids. However, oil-based fluids have certain performance advantages not usually associated with most water-based drilling fluids such as the ability to stabilize difficult shale formations. Silicate-based drilling fluids and potassium silicate drilling fluids in particular offer the same degree of shale stabilization as oil-based drilling fluids but also offer numerous HS&E advantages over oil-based drilling fluids.

A large volume of drilling waste needs to be disposed upon well completion. The toxicity and environmental performance of the drilling fluid and local government regulations dictate the disposal method for the drilling waste. FIG. 1 shows some of the potential disposal options for on-land drill waste. The specifics of the regulations for drilling waste disposal vary from jurisdiction to jurisdiction, however favorable agronomy represents a common theme; for example, drilling waste disposed on soil surfaces will have a specific limit as to how much the electrical conductivity and sodium absorption ratio can increase in the receiving soil.

Equation #1 shows the importance of limiting sodium and maintaining or increasing the concentration of soluble calcium and magnesium.

$$S A R = \frac{[ Na + ]}{\sqrt{\frac{1}{2} ( [ Ca + 2 ] + [ Mg + 2 ] )}} \qquad Equation \#1$$

Users of potassium silicate based drilling fluids have noted the need for calcium and/or magnesium amendments to meet SAR requirements. Typically, a calcium salt is added to the spent silicate drilling fluid and drill cuttings just prior to disposal. Potential salts include: calcium sulfate, calcium chloride or calcium nitrate as well as magnesium sulfate. These amendments suffer from one or more of the following disadvantages: cost, high electrical conductivity, and toxicity, low solubility at high pH, difficulty in dispersing into the drilling fluid or the additive adversely effects drilling fluid properties. The use of a humic substance reduces or eliminates these shortcomings.

Humic acids are large molecular organic weak-acid of carboxylic (COOH), hydroxyl (OH), and quinonic (C═O) groups. Humic acids are found naturally in soil in the form of humates, defined as the mineral or salt of humic acids. One type of humate is weathered sub-bituminous coal similar to leonardite or weathered lignite. This material has different chemical and physical characteristics than the ordinary coal (i.e. anthracite or bituminous). This material is considered to be non-hazardous.

Humic acid is represented by the following structure:

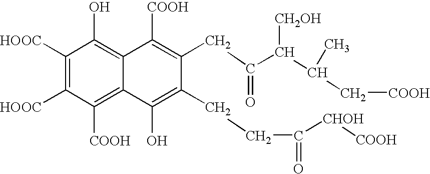

Among other things, humic acids have strong negative charges (from the COOH and OH groups) and therefore have a great affinity to cations, or identified as the cation exchange capacity (CEC). This makes humic acids an excellent natural chelating agent to common nutrients in agriculture. The use of humic acids have been proven improving the growth and yield of plants or maintaining the outputs by applying less nutrients due to a more efficient uptakes by plants. The weathered sub-bituminous coal itself is not readily soluble in water and therefore humic acids contained in it cannot effectively be utilized. This condition can easily be reversed by raising its pH to 7 or above using certain chemicals. Sodium and potassium salts or hydroxides have been found the best. At this condition, the material becomes active and is ready to capture cations. A typical weathered sub-bituminous coal has a CEC of over 600 meq/100 g.

This strong chelating ability is utilized in the remediation of drill-cuts, specifically in the reduction of the sodium adsorption ratio (SAR) while maintaining the same or even reducing its electrical conductivity (EC). Drilling cuttings coated with potassium silicate-based drilling fluid being one example.

In this new approach, a source of calcium and/or magnesium and weathered sub-bituminous coal is created as a main source of calcium and/or and humic acids. Potassium silicate-based drill waste typically has a pH above 10. This alkalinity provides optimum conditions for cation exchange between the drill waste and the humate. The importance of alkalinity makes humic material ideally suited for potassium silicate drilling fluids as well as other high pH systems with salinity. When the treated drill cuttings are mixed with background soil, the alkalinity of the drill cuttings is reduced and the final pH closely mirrors that of the unmodified soil. These conditions allow humic acid to form a bond with sodium and release a small amount of calcium and/or magnesium. It is thought that an equilibrium reaction is established for CEC based on drill waste soil conditions. This process is more holistic than the use of calcium and/or magnesium salts and results in the same or even lower SAR and EC values.

Sodium chelation by humic acids can be represented by the following model:
COO—Na+→(carboxyl group chelates sodium)
O—Na+→(hydroxyl group chelates sodium)

The addition of humic acids has an extra benefit when the soil mixture is applied to the agricultural land. Humic acids will chelate nutrients already present (but might not be available to plants) in soil, or the ones to be added in future. Humic acids also improve soil texture by breaking up aluminum-silicate bonds in clay lattices. Humic acids due to their colloidal form also retain more water in soil and provide available carbon to soil organisms.

Humic based products are currently used as additives in drilling fluids. These humic based products are used in oil based and water based drilling fluids. Their principle functions are decreasing fluid loss and as a thinner for rheology control. Examples of prior art include U.S. Pat. Nos.: Lawton et al. U.S. Pat. No. 1,999,766; Rahn U.S. Pat. No. 2,650,197; Wilson and Firth U.S. Pat. No. 4,311,600. Likewise, derivatives of humic based material have been disclosed for this use in drilling fluids as exemplified by Moschopedis U.S. Pat. No. 3,700,728. In this invention, humic material is being used as a beneficial amendment (vs. additive). As an amendment, the role of the humic material is to improve drilling waste characteristics so as to allow for easier and less expensive disposal. As an amendment, humic material is added to the drill waste. The invention does allow for humic material to be added to the drilling fluid near well completion. The addition of humic material to the drilling fluid is neutral to drilling fluid properties.

Von Krosigk, U.S. Pat. No. 6,852,675 relates to a nutrient source for marine organisms. It comprises a drilling fluid with organic contaminants, the use of a solidification agent, a cell transport agent and a cellulosic additive.

Drilling fluids containing alkali metal silicates have been used for decades for the drilling shale-containing formations. Vail et al., in U.S. Pat. No. 2,133,759, disclose muds containing alkali metal silicates. In U.S. Pat. No. 2,146,693, Vietti et al. disclosed a drilling fluid containing one of several sodium salts, including sodium silicate, the sodium salt content of the mud being in excess of 20% by weight. The following U.S. patents also disclose sodium silicate-containing drilling fluids: Vietti et al. U.S. Pat. No. 2,165,824; Garrison U.S. Pat. No. 2,239,647; and Garrison et al. U.S. Pat. No. 2,353,230. Recently, Dearing, U.S. Pat. No. 7,137,459 discloses a method of formulating an alkali metal silicate-containing drilling fluid. Solid silicate is added at the flowline at a rate of 0.1 to about 0.25% by weight of soluble silica.

### SUMMARY OF THE INVENTION

The present invention is based on the use of humic substances to improve the disposal of a water based drilling fluid containing salts at an alkaline pH and more specifically, a silicate based drilling fluid. Calcium oxide humate is an example of a cost-effective, readily available and environmentally-friendly humate substance. It can lower the SAR and EC of potassium silicate based drilling waste making it better suited for disposal. Humic based products may be added to the silicate based drilling fluid near well completion. Alternatively, the humic substance may be post-added to the drilling fluid and cuttings upon completion of drilling. Humic substances can also be added to the drill cuttings as they are separated from the drilling fluid.

### BRIEF DESCRIPTION OF THE DRAWINGS

FIG. 1 is a chart showing some of the potential disposal options for on-land drill waste

FIG. 2 shows drill cuttings being separated from a drilling fluid.

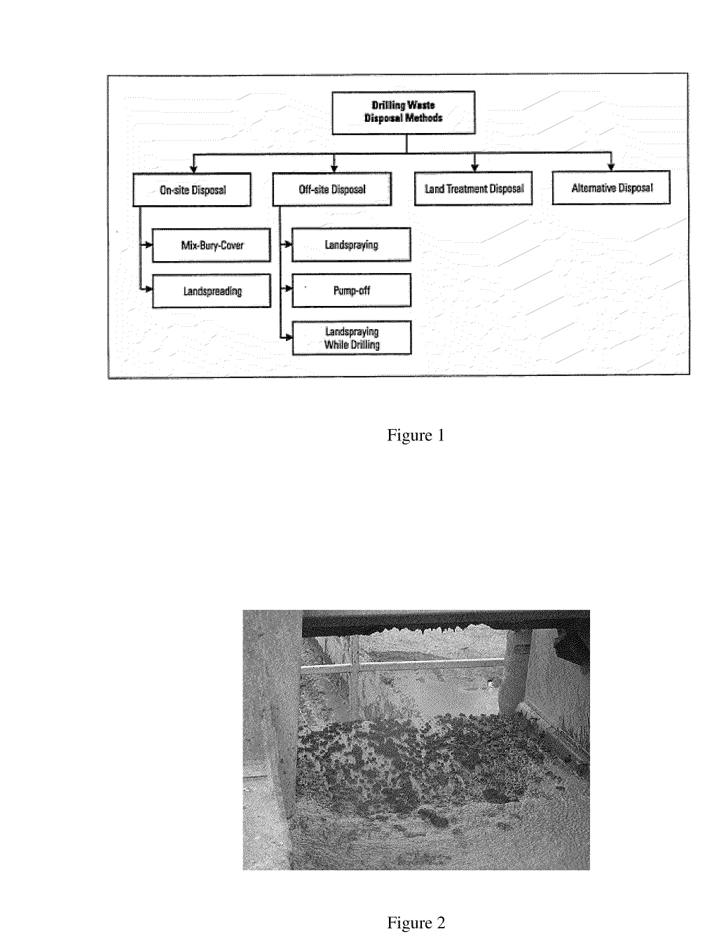

### DETAILED DESCRIPTION OF THE PREFERRED EMBODIMENTS

Prior to use, drilling fluids are formulated to a defined composition, however during use, the process of drilling results in an ever-changing drilling fluid composition. In the case of a soluble alkali silicate, the starting drilling fluid typically contains (disregarding a wide variety of additives such as weighting agents, rheology agents, lubricants etc):

(i) 80-99.5% water v/v

(ii) 20% to 0.5% alkali metal silicate v/v

Silicates useful in carrying out the present invention include material in solution as well as hydrated and anhydrous solids, exhibiting molar ratios of SiO₂ to Na₂O or K₂O in the range of 1.5 to 4.0. Table 1 indicates the most commonly used potassium silicate.

TABLE 1
Properties of Potassium Silicate

| | |
|---|---|
| mol. ratio of SiO2/K2O | 3.90 |
| Wt. ratio of SiO2/K2O | 2.50 |
| % SiO₂ | 20.8% |
| % K₂O | 8.3% |
| Density | 1.26 |
| pH | 11.3 |
| viscosity | 40 centipoise |
| characteristics | water clear |

Given the importance of drilling fluids to the success of a drilling operation, the properties of the drilling fluid are routinely measured by a properly trained field hand. These properties include fluid loss and rheology. Humic substances can be added to a drilling fluid prior to well completion without adversely affecting such drilling fluid properties as rheology and fluid loss.

In the case of silicate based drilling fluids, testing includes measuring the concentration and properties of the alkali silicate. Silicate concentration and properties are determined by two titrations. The first titration measures the alkali concentration (expressed as K₂O for potassium silicate and Na₂O for sodium silicate) while the second titration determines soluble silica concentration (SiO₂). These titrations provide an indication of alkali silicate concentration and ratio (SiO₂:K₂O). Alkali silicate is depleted during the drilling process. The depletion rate of alkali silicate being a function of drill rate, hole size, formation type and temperature. Typically, alkali silicate is added on a daily basis to maintain the desired alkali silicate concentration. In general terms, alkali silicate concentration is proportional to the degree of the difficulty of shale stabilization.

Drill cuttings are brought to the surface by the drilling fluid. At the surface, the drilling fluid and drill cuttings are passed over shakers that separate the drill cuttings from the drilling fluid. (see FIG. 2). Cuttings are collected and stored on the drill site prior to disposal. At any point, an appropriate humic based product could be added to the cuttings pile. The addition of a humic substance to the cuttings pile would reduce SAR and EC.

Drilling fluid properties of fluid loss and rheology were measured using American Petroleum Institute (API) Recommended Practice 13B-1. Sodium adsorption ratio (SAR) was determined by saturated paste, based on McKeague, Manual on Soil Sampling and Analysis, Method 3.21

### EXAMPLE 1

A composite sample of potassium silicate based drilling fluid, drill cuttings and subsoil was taken from a gas well in Southern Alberta. Table 1a indicates the salinity properties of drill waste (cuttings & fluids) and the subsoil.

Table 1b shows the effect on electrical conductivity on drilling fluid & cuttings with the addition of different amendments (1% weight to weight)

Table 1c shows the effect on electrical conductivity and sodium absorption ratio when 1 part treated cuttings is combined with 3 parts subsoil (volume to volume)

TABLE 1a
Salinity Properties

| | % pot. | | | |
|---|---|---|---|---|
| | Silicate | E.C. | pH | SAR |
| Drilling fluid | 4.7 | 10.1 dS/m | 11.4 | 213 |
| Drill cuttings | 1.7 | 6.3 | 11.0 | 103 |
| Subsoil* | — | .98 | 8.7 | 3.8 |

*subsoil would be described as clay-based

TABLE 1b
Electrical Conductivity vs. Amendment

| | Control | | | |
|---|---|---|---|---|
| | No | 1% | 1% | |
| | amendment | Ca Hum | gyp | 1% epsom |
| EC-drilling | 10.1 | 9.3 | 13.9 | 12.1 |
| fluid dS/m | | | | |
| EC-cuttings | 6.3 | 5.6 | 15 | 16.1 |
| dS/m | | | | |

TABLE 1c
Soil & Cuttings (3:1) vs. SAR & EC

| | | Control | Cuttings + | Cuttings + | |
|---|---|---|---|---|---|
| | Control | Untreated | 1% | 1% | Cuttings + |
| | (water) | cuttings | Ca Hum | gypsum | 1% epsom |
| EC dS/m | .98 | 2.28 | 2.60 | 14.2 | 11.6 |
| SAR | 3.6 | 14.1 | 7.4 | 8.3 | 9.0 |

### EXAMPLE 2

Example 2 evaluated the effect that calcium humates had on the drilling fluid properties of fluid loss and rheology. Rheology and fluid loss showed minimal changes between the untreated drilling waste (control) and the calcium humate amended drilling waste (table 2b)

Also tested was the electrical conductivity of the drilling fluid as well as the drilling fluid filtrate. Testing was done on a lab prepared drilling fluid using gypsum and hydrated lime as controls.

TABLE 2a
Simulated Drilling Fluid

| | | |
|---|---|---|
| Water | 930 | m |
| Potassium Silicate | 70 | ml |
| Xanthan gum | 2 | g |
| Starch | 2 | g |
| PAC | 2 | g |
| Rev Dust | 30 | g |

### Example 2b

### Fluid Loss vs. Calcium Amendment

| | Fluid Loss (ml) | |
|---|---|---|
| Control | 8.3 | ml |
| +1% CaO humate | 9.2 | |
| +1% CaSO₄ humate | 8.1 | |
| +1% gypsum | 20.2 | |
| +1% hydrated lime | 15.0 | |

Note:
1% wt/wt, shear mixed and tested after ~24 hrs at room temperature

### Example 2c

### Rheology vs. Calcium Amendment

| | | | | | | | | 10 min |
|---|---|---|---|---|---|---|---|---|
| | 600 rpm | 300 rpm | 200 rpm | 100 rpm | 6 rpm | 3 rpm | 10 s gel | gel |
| Control | 42 | 30 | 25 | 18 | 5 | 4 | 6 | 6 |
| +1% CaO humate | 45 | 32 | 25 | 18 | 5 | 4 | 6 | 6 |
| +1% CaSO₄ humate | 45 | 31 | 25 | 18 | 5 | 4 | 6 | 6 |
| +1% gypsum | 81 | 58 | 48 | 36 | 13 | 11 | 12 | 13 |
| +1% hydrated lime | 65 | 47 | 39 | 29 | 10 | 8 | 10 | 11 |

Note:
1% wt/wt, shear mixed and tested after ~24 hrs at room temperature

### EXAMPLE 3

Example 3 compares the EC of after the addition of different amendments. Amendments were added 1% wt to wt to the drilling fluid. Testing was done on the lab prepared drilling fluid as well as a fluid taken from a well site. The drilling fluid from the field was a mixture of water, dispersed drill solids, polymers and had a concentration of ˜8% v/v potassium silicate.

### Example 3

### Electrical Conductivity (dS/m) vs. Amendment, 1% Amendment wt/wt Drilling Fluid

| | | CaO | CaSO₄ | Ca. | | | |
|---|---|---|---|---|---|---|---|
| | control | humate | humate | ligno | Gyp | EDTA | Epsom Salt |
| Field Mud #2 dS/m | 9.24 | 8.04 | 8.58 | 8.48 | 10.03 | 12.95 | 10.52 |
| Lab Mud dS/m | 10.15 | 8.90 | 9.17 | 9.74 | 12.13 | 13.46 | 10.88 |

### EXAMPLE 4

Example 4 shows the effect of calcium humate concentration on EC (dS/m). Testing was done on the drilling fluids used in Example 3.

### Example 4

### Electrical Conductivity vs. Humate Loading

| | | | | | 1% | 2% | 4% |
|---|---|---|---|---|---|---|---|
| | | 1% CaO | 2% CaO | 4% CaO | CaSO₄ | CaSO₄ | CaSO₄ |
| | control | humate | Humate | humate | humate | humate | humate |
| Field Mud #2 | 9.24 | 8.04 | 7.28 | 5.80 | 8.58 | 8.05 | 8.25 |
| dS/m | | | | | | | |
| Lab mud | 10.18 | 8.94 | 8.01 | 7.03 | 9.36 | 9.37 | 9.91 |
| dS/m | | | | | | | |

The effectiveness of calcium oxide humate at reducing salinity was also tested in non potassium silicate drilling fluids. Basic drilling fluid was formulated according to table 5a. Post added to the drilling fluid were commonly used drilling fluid additives. Additives were added on a weight to weight basis. After approximately 16 hrs, calcium humate was added at a 2% wt/wt loading, mixed and allowed to stand for approximately 16 hrs. Salinity as measured by electrical conductivity was reduced with drilling fluids amended with calcium oxide humate (Table 5b).

TABLE 5a
Simulated Drilling Fluid

| | |
|---|---|
| Water | 1000 g |
| Soda ash | 5 g |
| Xanthan gum | 2 g |
| Starch | 2 g |
| Polyanionic cellulose | 2 g |
| Rev Dust | 20 g |
| Sodium Hydroxide (50% | 5 g |
| solution) | |

TABLE 5b
EC vs. Drilling Fluid vs.Calcium Humate - High Alkalinity

| | | | | +0.5% | | +1% | | |
|---|---|---|---|---|---|---|---|---|
| | Control | control + | | NaCl + | | hexadiamine + | | +2% KCl + |
| | (only soda | 2% Ca. | | 2% Ca | +1% | 2% Ca | | 2% Ca |
| | ash) | Hum | +0.5% NaCl | Hum | hexadiamine | Hum | +2% KCl | Hum |
| EC | 10.9 | 8.1 | 18.1 | 14.8 | 9.8 | 7.9 | 34.3 | 23.7 |

all fluids contain 0.5% soda ash plus post addition of 0.5% NaOH (50% concentration)
samples aged for >16 hrs

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. Patents and publications mentioned in this application are hereby incorporated by reference as if fully rewritten herein.

1. A method for decreasing detrimental environmental properties of a water-based drilling fluid comprising the step of administering at least one of a humic and fulvic substance to said fluid.

2. The method of claim 1, wherein said water-based drilling fluid is a silicate based drilling fluid.

3. The method of claim 2, wherein said drilling fluid is a potassium silicate drilling fluid.

4. The method of claim 3, wherein said humic substance is selected from the group consisting of calcium oxide humate, calcium sulfate humate and magnesium oxide humate.

5. The method of claim 1, wherein said at least one of a humic and fulvic substance is added to said water-based drilling fluid to lower the electrical conductivity and to improve the sodium absorption ratio thereof.

6. The method of claim 1, where said at least one of a humic and fulvic substance is added to said water-based drilling fluid to decrease the salinity thereof.
